(19) United States
(12) Patent Application Publication
(10) Pub. No.: US 2026/0133786 A1
(43) Pub. Date: May 14, 2026

(54) PREDICTIVE SYSTEM DIAGNOSTICS

(71) Applicant: DELL PRODUCTS L.P., Round Rock, TX (US)

(72) Inventor: Hemanth Venkatesh Murthy, Bengaluru (IN)

(21) Appl. No.: 18/946,229

(22) Filed: Nov. 13, 2024

(51) Int. Cl. G06F 8/65; G06F 1/3206

(52) U.S. Cl. CPC G06F 8/65; G06F 1/3206

(57) ABSTRACT

An information handling system including a processor and a memory coupled to the processor. The processor may be configured to monitor the information handling system to detect whether an information handling system is in a low power state. If the information handling system is in the low power state, then power consumption of the information handling system may be monitored. If the power consumption of the information handling system deviates from an expected power consumption of the information handling system, then a diagnostic routine may be performed.

### FIELD OF THE DISCLOSURE

The present disclosure generally relates to information handling systems, and more particularly relates to predictive system diagnostics.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communication among information handling systems may be via networks that are wired, wireless, or some combination.

### SUMMARY

An information handling system includes a processor and a memory coupled to the processor. The processor may be configured to monitor the information handling system to detect whether an information handling system is in a low power state. If the information handling system is in a low power state, then power consumption of the information handling system may be monitored. If the power consumption of the information handling system deviates from an expected power consumption of the information handling system, then a diagnostic routine may be performed.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a system for predictive system diagnostics, according to an embodiment of the present disclosure;

FIG. 2 is a flowchart of a method for predictive system diagnostics, according to an embodiment of the present disclosure; and

FIG. 3 is a block diagram of an information handling system, according to an embodiment of the present disclosure;

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Diagnostics modules are sometimes installed on information handling systems either during manufacture or downloaded after purchase. If a user has difficulty with the information handling system, the user typically runs the diagnostics module to attempt to isolate the problem. However, current diagnostics techniques generally detect failures after they have occurred. For example, motherboard failures are typically detected after the motherboard fails and an information handling system is unable to boot up. This generally results in frustration for the user and expense to the manufacturer and/or distributor of the information handling system as they address the issue. As such, being able to predict and address an issue before it occurs may increase a user's satisfaction and minimize the additional expense of the manufacturer and/or distributor. Accordingly, the present disclosure provides a system and method for predictive system diagnostics using artificial intelligence techniques to predict issues before they cause the information handling to fail.

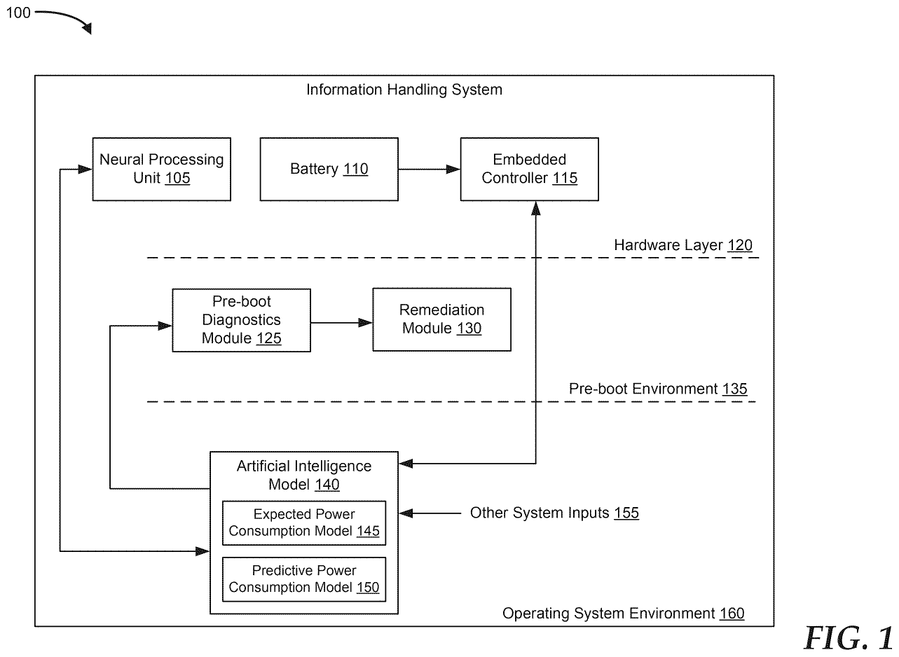

FIG. 1 illustrates a portion of an information handling system 100 for predictive system diagnostics, according to an embodiment of the present disclosure. Information handling system 100 includes a hardware layer 120, a pre-boot environment 135, and an operation system environment 160. Information handling system 100 also includes a neural processing unit (NPU) 105, a battery 110, an embedded controller 115, a pre-boot diagnostics module 125, a remediation module 130, an artificial intelligence model 140, and other system inputs 155. Artificial intelligence model 140 includes expected power consumption model 145 and predictive power consumption model 150.

Embedded controller 115 may be connected to battery 110 and artificial intelligence model 140, which may be connected to NPU 105, pre-boot diagnostics module 125, and other system inputs 155. Pre-boot diagnostics module 125 may be connected to remediation module 130. However, any variety of connections between NPU 105, battery 110, embedded controller 115, pre-boot diagnostics module 125, remediation module 130, artificial intelligence model 140, and other system inputs 155 are envisioned as falling within the scope of the present disclosure. In addition, connections between components may be omitted for descriptive clarity. The operations described herein as being performed by embedded controller 115, pre-boot diagnostics module 125, and remediation module 130 may be executed via a processor or central processing unit (CPU). The CPU and/or NPU 105 may perform any suitable operation to execute artificial intelligence model 140.

Power consumption during run state generally varies based on usage scenarios. Monitoring the power consumption of an information handling system during a low power state may give an indication of the motherboard and/or information handling system's health. An embedded controller may be used to monitor the power consumption of the information handling system at low power or off state. The power consumption may be compared to a baseline or expected power consumption. A deviation from the baseline or expected power consumption may predict an issue with one or more components of the information handling system.

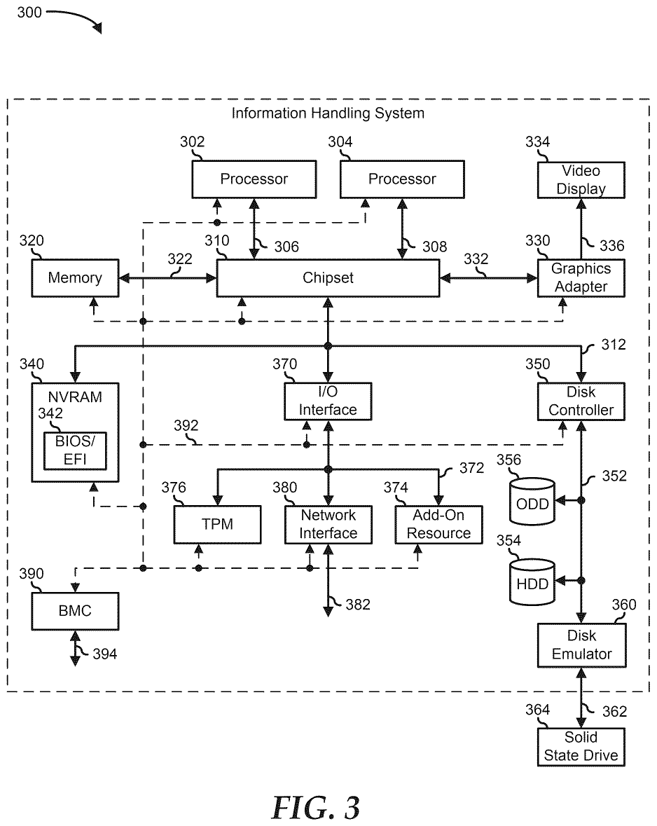

Information handling system 100, which is similar to information handling system 300 of FIG. 3, maybe a personal computer, a desktop computer system, a laptop computer system, a server computer system, a mobile device, a tablet computing device, a personal digital assistant, a consumer electronic device, an electronic music player, an electronic camera, an electronic video player, a wireless access point, a network storage device, or any other suitable computing device. Hardware layer 120 of information handling system 100 includes a collection of physical components configured to perform operations of information handling system 100, such as NPU 105, battery 110, and embedded controller 115.

NPU 105 may comprise any system, device, or apparatus configured and optimized to handle the complex computations required by artificial intelligence, machine learning, and/or deep learning algorithms. This optimization makes an NPU efficient at processing artificial intelligence, machine learning, and/or deep learning tasks, such as natural language processing, image analysis, and more. The NPU utilized by information handling system 100 may be of various types including a discrete NPU and an integrated NPU. Accordingly, NPU 105 may be configured to execute a workload associated with artificial intelligence model 140.

Battery 110 may be configured to supply power to various components of information handling system 100. In one embodiment, battery 110 can be multiple Li-ion cells that are connected in series or parallel. Battery 110 can supply a range of voltages and currents depending on the requirements of information handling system 100. Embedded controller 115, which may be similar to BMC 390 of FIG. 3, may comprise any system, device, or apparatus configured to manage and control information handling system 100 and/or its components, such as to monitor the power consumption of battery 110.

For example, embedded controller 115 may include a battery monitor, which is software or firmware that collects battery usage to determine the power consumption of information handling system 100 in various states, such as at low power state and/or off state. Embedded controller 115 may monitor the overall power consumption of information handling system 100 during the low power or off state. Embedded controller 115 may also monitor the power consumption of one or more components of information handling system 100, such as a CPU, random access memory (RAM), synchronous dynamic RAM (SDRAM), motherboard, solid-state drive (SSD), system fan, etc. at the low power state or off state. Embedded controller 115 may also monitor the charging rate of battery110. Embedded controller 115 may provide the collected information to artificial intelligence model 140. Embedded controller 115 may also be configured to enforce a policy that dictates the execution of a specific artificial intelligence model or a specific type of artificial intelligence model with certain parameter(s) in response to detecting that information handling system 100 is at a low power state, off state, or when power consumption drops below or rises above a minimum value.

Pre-boot environment 135, which includes pre-boot diagnostics module 125 and remediation module 130, may refer to when information handling system 100 is controlled by BIOS and not an operating system. Pre-boot diagnostics module 125 may comprise any system, device, or apparatus configured to detect and identify one or more faults or issues associated with a hardware or software component of information handling system 100. Pre-boot diagnostics module 125 may also be configured to interact with a user via a display device coupled to information handling system 100 and may be capable of taking direction from the user via a keyboard, a mouse, or a similar user interface. Pre-boot diagnostics module 125 may be stored in a standard electrically erasable programmable read-only memory (EEPROM), a flash EEPROM, or a standard ultraviolet erasable programmable read-only memory (“UV-PROM”). The diagnostics can be embedded in random-access memory (RAM) (typically complementary metal oxide semiconductor (“CMOS”) RAM), so long as the RAM retains the diagnostics when the computer is otherwise powered down. In addition, pre-boot diagnostics module 125 and/or remediation module 130 may be configured to trigger a service alert or notify the user when a system component is predicted to fail. Pre-boot diagnostics module 125 may also log information related to the diagnostic and/or error data.

Pre-boot diagnostics module 125 may detect one or more issues based on deviations in power consumption of information handling system 100 during the low power state or suspend state. In particular, pre-boot diagnostics module 125 may determine which component of information handling system 100 may have caused a deviation in the power consumption. For example, during the low power state or suspend state, the SDRAM may be the only component that is active. Accordingly, if there is a deviation from the expected power consumption at this state, then this may indicate that there is an issue with the SDRAM like a dual in-line memory module (DIMM) corrosion. The deviation may also indicate an issue with a system fan if it is consuming more power with the same revolutions per minute (RPM) during the low power state. In another example, if there is a deviation from the expected power consumption during an off state, then this may indicate that there is a short in the motherboard or that a component, such as a management engine or embedded controller 115 is draining battery 110. This deviation may also indicate a degradation of battery 110 when battery 110 is unexpectedly discharged, or if there is an increase or decrease in the charging time of battery 110.

Remediation module 130 may comprise any system, device, or apparatus configured to address, remediate, or resolve one or more predicted issues of information handling system 100 and/or its various components. In one embodiment, remediation module 130 may create and/or execute a remediation script to resolve an issue reported by pre-boot diagnostics module 125. For example, to address a predictive degradation of the system fan, remediation module 130 may reverse the direction of the rotation of the system fan. This may remove dust buildup which can have a thermal impact on information handling system 100. Remediation module 130 may also address the issue by notifying the user that there is a possible issue with the system fan. In addition to the notification, remediation module 130 may provide steps for the user to take action such as inspecting information handling system 100 for clogged or obstructed vents and cleaning the vents of excess lint, dust, or debris. Remediation module 130 may also update a firmware, such as the system fan firmware or BIOS firmware to remediate the identified issue.

In another example, to address a possible degradation of battery 110, remediation module 130 may change the charging rate of battery 110, which can enhance the battery life of battery 110. Similar to the above, remediation module 130 may notify the user that there is a possible issue with battery 110 and provide a resolution to address the issue. For example, remediation module 130 may instruct the user to run a specific battery diagnostics software. Remediation module 130 may also update a firmware, such as the battery firmware or BIOS firmware to resolve the issue. In yet another example, to address a possible issue with the SDRAM, remediation module 130 may initiate hardware self-check and/or memory checks. Remediation module 130 may also provide an error code and instruct the user to contact technical support with the error code.

Operating system environment 160, which includes artificial intelligence model 140 and other system inputs 155, may refer to when information handling system 100 is controlled by the operating system. Artificial intelligence model 140 may implement a neural network, fuzzy logic, deep learning, deep structured learning hierarchical learning, support vector machine (SVM), decision tree learning, dimensionality reduction, or the like. The neural network may include an artificial neural network, deep neural network, convolutional neural network, recurrent neural network, transformers, autoencoders, reinforcement learning, etc. The SVM may include linear SVM, nonlinear SVM, SVM regression, etc. The decision tree learning may include classification and regression tree or “CART”) etc. Artificial intelligence model 140 may include more than one artificial intelligence model. For example, artificial intelligence model 140 may include a first artificial learning model, such as an expected power consumption model 145 that is configured to learn the expected power consumption of a specific model or configuration of an information handling system during training.

Artificial intelligence model 140 may also include a second artificial learning model, such as predictive power consumption model 150 that is configured to detect one or more deviations in power consumption of information handling system 100 from its expected power consumption. In one particular example, predictive power consumption model 150 may implement a classification model, such as a binary classification model where it can indicate whether the current power consumption of information handling system 100 deviates from the expected power consumption or not. The current power consumption deviates from the expected power consumption if the current power consumption is higher or lower than the expected power consumption.

Expected power consumption model 145 includes parameters and values for power consumption of information handling system 100 and/or its components. Examples of the parameters and values include support for power monitoring which further includes, minimum, maximum, and average power consumption for information handling system 100 or each of various components over a pre-determined monitored period time intervals, such as every minute, five minutes, etc. through a historical time period. Expected power consumption model 145 may be executed in a laboratory setting during the manufacture of a particular type or model of an information handling system to determine the expected power consumption of the particular type or model information handling system and/or its various components at a desired level during a low power or off state.

The information provided by expected power consumption model 145 can be used by predictive power consumption model 150 to determine a deviation from the expected power consumption, such as the expected minimum and maximum power consumption of information handling system 100 or its various components. The deviation may be used to predict fault or likelihood of a malfunction of a particular component. Predictive power consumption model 150 may transmit a signal and/or instruction to pre-boot diagnostics module 125 when it detects a deviation. Pre-boot diagnostics module 125 upon receipt of the signal and/or instruction may then initiate a diagnostics process of information handling system 100 and/or its various components. The diagnostics process may include booting information handling system 100 to pre-boot environment 135.

Other system inputs 155 may comprise various inputs from one or more components, such as a sensor or a monitoring service. The monitoring service may be configured to monitor, control, and/or manage one or more features of information handling system 100, such as the health and performance of information handling system 100. As such, the monitoring service includes one or more monitoring services, wherein each monitoring service may monitor, control, and/or manage a feature of information handling system 100. For example, the monitoring service may include a performance monitor, a power monitor, an acoustics monitor, a thermal monitor, a reliability monitor, etc.

Those of ordinary skill in the art will appreciate that the configuration, hardware, and/or software components of information handling system 100 may vary. For example, the illustrative components within information handling system 100 are not intended to be exhaustive, but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description. In another example, while pre-boot diagnostic module 125 and remediation module 130 are located in pre-boot environment 135, the aforementioned components may be located in operating system environment 160. Accordingly, pre-boot diagnostic module 125 may be referred to simply as a diagnostic module.

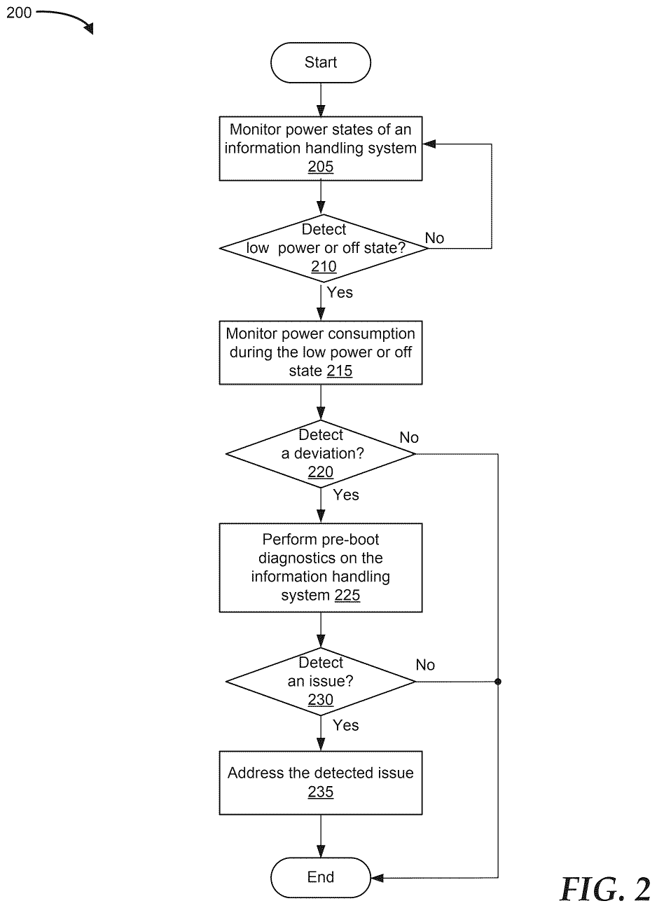

FIG. 2 illustrates a flowchart of a method 200 for predictive system diagnostics, according to an embodiment of the present disclosure. Method 200 may be performed by any suitable component of information handling system 100 including, but not limited to, NPU 105, embedded controller 115, pre-boot diagnostics module 125, remediation module 130, and artificial intelligence model 140 of FIG. 1. While embodiments of the present disclosure are described in terms of the components of information handling system 100 of FIG. 1, it should be recognized that other components may be utilized to perform the described method. One of skill in the art will appreciate that this flowchart explains a typical example, which can be extended to applications or services in practice. In addition, it will be readily appreciated that not every method step set forth in this flow diagram is always necessary and that certain steps of the methods may be combined, performed simultaneously, in a different order, or perhaps omitted, without varying from the scope of the disclosure.

In one embodiment, method 200 may utilize artificial intelligence techniques to leverage collected data to learn an expected power consumption of a particular model or configuration of an information handling system and/or various components during training of an artificial intelligence or machine learning model. Based on the learned expected power consumption, the method may further determine whether a current power consumption deviates from the expected power consumption at an off state or low power state. The off state may also be referred to as a system shutdown or S5 state. The low power state may include states wherein the information handling system is in an idle state, modern standby, sleeping state, hibernate state, or the like.

Method 200 typically starts at block 205 where an embedded controller may monitor the power states of an information handling system. Prior to block 205, the expected power consumption of an information handling system during a low power state or off state may be monitored. This monitoring may be performed in a factory or laboratory setting for each model or configuration of the information handling system. The method may proceed to block 210 where the embedded controller may determine whether it detects that the information handling system is in a low power or off state. If the embedded controller detects that the information handling system is in a low power or off state, then the “YES” branch is taken, and the method proceeds to block 215. If the embedded controller does not detect that the information handling system is in the low power or off state, then the “NO” branch is taken, and the method proceeds to block 205 where it may continue monitoring the power state of the information handling system.

At block 215, the embedded controller may collect data to monitor the current power consumption of the information handling system during its low power state or off state. The embedded controller may provide the collected data to a predictive power consumption model, which may use artificial intelligence or machine learning techniques to determine deviation from the expected power consumption for the low power state or off state. The method may proceed to decision block 220 where the predictive power consumption model may determine whether it detects a deviation in the current power consumption versus the expected power consumption of the information handling system during the low power state or off state. If the predictive power consumption model detects that the current power consumption deviates from the expected power consumption, then the “YES” branch is taken, and the method proceeds to block 225. If the predictive power consumption model detects that the current power consumption does not deviate from the expected power consumption, then the “NO” branch is taken, and the method ends. Prior to proceeding to block 225, the predictive power consumption model and/or the embedded controller may set a diagnostic flag to true from a false state.

At block 225, a pre-boot diagnostics module may perform a health scan or other diagnostic routine of the information handling system without using an operating system. The health scan and diagnostic routine may include hardware diagnostic testing such as CPU operation testing, RAM integrity testing; battery health, capacity, and output capability testing; battery charger operation testing, system storage, system board and motherboard operation testing, input/output device operation testing, graphics card operation testing, cooling fan operation testing, analysis of event logs for the presence of failure records, etc. CPU operation testing includes machine check exception presence, thermal, cache, and speed testing. Testing of the system storage includes solid state, hard drive, and optical drive testing. The motherboard testing includes a CMOS battery, input/output, clock, timer, and interrupt testing. The testing of the input/output device includes touchpad, mouse, keyboard, display, and touchscreen operation testing.

The pre-boot diagnostics module may boot the information handling system to a pre-boot environment prior to testing or perform the diagnostics at the next boot sequence, wherein the pre-boot diagnostics module may check the diagnostics flag and proceed with the health scan or diagnostics if true. The pre-boot diagnostics module may also notify the user regarding the initialization of the pre-boot diagnostics and/or possible reboot to a pre-boot environment. The pre-boot diagnostics module may or may not provide an option for the user to cancel the diagnostics.

At decision block 230, the pre-boot diagnostics module may determine whether it detects an issue with one or more components of the information handling system. If the pre-boot diagnostics module detects an issue with the information handling system, then the “YES” branch is taken, and the method proceeds to block 235. If the pre-boot diagnostics module does not detect an issue with the information handling, then the “NO” branch is taken, and the method ends.

At block 235, a remediation module may address the detected issue, such as performing a remediation routine if applicable. In one embodiment, the pre-boot diagnostics may automatically trigger the remediation module to remediate or resolve the issue. If the issue cannot be remediated or resolved without a possible intervention by a service technician, such as to replace a part, then the remediation module may display a warning for the user. For example, the remediation module may update one or more firmware, trigger a service alert, display a notification to the user, among others. The pre-boot diagnostics module and/or remediation module may generate a diagnostics code that may be included in the service alert and/or notification. The diagnostics code may be used by the service technician at a service center to analyze and verify the failure of the information handling system. Afterwards, the method ends.

FIG. 3 illustrates an embodiment of an information handling system 300 including processors 302 and 304, a chipset 310, a memory 320, a graphics adapter 330 connected to a video display 334, a non-volatile RAM (NVRAM) 340 that includes a basic input and output system/extensible firmware interface (BIOS/EFI) module 342, a disk controller 350, a hard disk drive (HDD) 354, an optical disk drive (ODD) 356, a disk emulator 360 connected to an SSD 364, an I/O interface 370 connected to an add-on resource 374 and a trusted platform module (TPM) 376, a network interface 380, and a BMC 390. Processor 302 is connected to chipset 310 via processor interface 306, and processor 304 is connected to the chipset via processor interface 308. In a particular embodiment, processors 302 and 304 are connected together via a high-capacity coherent fabric, such as a HyperTransport link, a QuickPath Interconnect, or the like. Chipset 310 represents an integrated circuit or group of integrated circuits that manage the data flow between processors 302 and 304 and the other elements of information handling system 300. In a particular embodiment, chipset 310 represents a pair of integrated circuits, such as a northbridge component and a southbridge component. In another embodiment, some or all of the functions and features of chipset 310 are integrated with one or more with processors 302 and 304.

Memory 320 is connected to chipset 310 via a memory interface 322. An example of memory interface 322 includes a DDR memory channel and memory 320 represents one or more DDR DIMMs. In a particular embodiment, memory interface 322 represents two or more DDR channels. In another embodiment, one or more of processors 302 and 304 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 320 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 330 is connected to chipset 310 via a graphics interface 332 and provides a video display output 336 to a video display 334. An example of a graphics interface 332 includes a PCIe interface and graphics adapter 330 can include a four-lane (x4) PCIe adapter, an eight-lane (x8) PCIe adapter, a 16-lane (x16) PCIe adapter, or another configuration, as needed or desired. In a particular embodiment, graphics adapter 330 is provided down on a PCB. Video display output 336 can include a Digital Video Interface (DVI), a High-Definition Multimedia Interface (HDMI), a DisplayPort interface, or the like, and video display 334 can include a monitor, a smart television, an embedded display such as a laptop computer display, or the like.

NVRAM 340, disk controller 350, and I/O interface 370 are connected to chipset 310 via an I/O channel 312. An example of I/O channel 312 includes one or more point-to-point PCIe links between chipset 310 and each of NVRAM 340, disk controller 350, and I/O interface 370. Chipset 310 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface, a Universal Serial Bus (USB), another interface, or a combination thereof. NVRAM 340 includes BIOS/EFI module 342 that stores machine-executable code (BIOS/EFI code) that operates to detect the resources of information handling system 300, to provide drivers for the resources, to initialize the resources, and to provide common access mechanisms for the resources. The functions and features of BIOS/EFI module 342 will be further described below.

Disk controller 350 includes a disk interface 352 that connects the disc controller to a hard disk drive (HDD) 354, to ODD 356, and to disk emulator 360. An example of disk interface 352 includes an Integrated Drive Electronics (IDE) interface, an Advanced Technology Attachment (ATA) such as a parallel ATA (PATA) interface or a SATA interface, a SCSI interface, a USB interface, a proprietary interface, or a combination thereof. Disk emulator 360 permits SSD 364 to be connected to information handling system 300 via an external interface 362. An example of external interface 362 includes a USB interface, an institute of electrical and electronics engineers (IEEE) 1394 (Firewire) interface, a proprietary interface, or a combination thereof. Alternatively, SSD 364 can be disposed within information handling system 300.

I/O interface 370 includes a peripheral interface 372 that connects the I/O interface to add-on resource 374, to TPM 376, and to network interface 380. Peripheral interface 372 can be the same type of interface as I/O channel 312 or can be a different type of interface. As such, I/O interface 370 extends the capacity of I/O channel 312 when peripheral interface 372 and the I/O channel are of the same type, and the I/O interface translates information from a format suitable to the I/O channel to a format suitable to the peripheral interface 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on a separate circuit board, or add-in card disposed within information handling system 300, a device that is external to the information handling system, or a combination thereof.

Network interface 380 represents a network communication device disposed within information handling system 300, on a main circuit board of the information handling system, integrated onto another component such as chipset 310, in another suitable location, or a combination thereof. Network interface 380 includes a network channel 382 that provides an interface to devices that are external to information handling system 300. In a particular embodiment, network channel 382 is of a different type than peripheral interface 372 and network interface 380 translates information from a format suitable to the peripheral channel to a format suitable to external devices.

In a particular embodiment, network interface 380 includes a NIC or host bus adapter (HBA), and an example of network channel 382 includes an InfiniBand channel, a Fibre Channel, a Gigabit Ethernet channel, a proprietary channel architecture, or a combination thereof. In another embodiment, network interface 380 includes a wireless communication interface, and network channel 382 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 382 can be connected to an external network resource (not illustrated). The network resource can include another information handling system, a data storage system, another network, a grid management system, another suitable resource, or a combination thereof.

BMC 390 is connected to multiple elements of information handling system 300 via one or more management interface 392 to provide out of band monitoring, maintenance, and control of the elements of the information handling system. As such, BMC 390 represents a processing device different from processor 302 and processor 304, which provides various management functions for information handling system 300. For example, BMC 390 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 390 can vary considerably based on the type of information handling system. BMC 390 can operate in accordance with an Intelligent Platform Management Interface (IPMI). Examples of BMC 390 include an Integrated Dell® Remote Access Controller (iDRAC).

Management interface 392 represents one or more out-of-band communication interfaces between BMC 390 and the elements of information handling system 300, and can include an Inter-Integrated Circuit (I²C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 302 and 304 and procedures that are implemented on the information handling system in response to the executed code.

BMC 390 operates to monitor and maintain system firmware, such as code stored in BIOS/EFI module 342, option ROMs for graphics adapter 330, disk controller 350, add-on resource 374, network interface 380, or other elements of information handling system 300, as needed or desired. In particular, BMC 390 includes a network interface 394 that can be connected to a remote management system to receive firmware updates, as needed or desired. Here, BMC 390 receives the firmware updates, stores the updates to a data storage device associated with the BMC, and transfers the firmware updates to NVRAM 340 of the device or system that is the subject of the firmware update, thereby replacing the currently operating firmware associated with the device or system, and reboots information handling system, whereupon the device or system utilizes the updated firmware image.

BMC 390 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 390, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by an “F2” boot option, or another protocol or API, as needed or desired.

In a particular embodiment, BMC 390 is included on a main circuit board (such as a baseboard, a motherboard, or any combination thereof) of information handling system 300 or is integrated onto another element of the information handling system such as chipset 310, or another suitable element, as needed or desired. As such, BMC 390 can be part of an integrated circuit or a chipset within information handling system 300. An example of BMC 390 includes an iDRAC, or the like. BMC 390 may operate on a separate power plane from other resources in information handling system 300. Thus BMC 390 can communicate with the management system via network interface 394 while the resources of information handling system 300 are powered off. Here, information can be sent from the management system to BMC 390 and the information can be stored in a RAM or NVRAM associated with the BMC. Information stored in the RAM may be lost after power-down of the power plane for BMC 390, while information stored in the NVRAM may be saved through a power-down/power-up cycle of the power plane for the BMC.

Information handling system 300 can include additional components and additional buses, not shown for clarity. For example, information handling system 300 can include multiple processor cores, audio devices, and the like. While a particular arrangement of bus technologies and interconnections is illustrated for the purpose of an example, one of skill will appreciate that the techniques disclosed herein are applicable to other system architectures. Information handling system 300 can include multiple CPUs and redundant bus controllers. One or more components can be integrated together. Information handling system 300 can include additional buses and bus protocols, for example, I²C and the like. Additional components of information handling system 300 can include one or more storage devices that can store machine-executable code, one or more communications ports for communicating with external devices, and various input and output (I/O) devices, such as a keyboard, a mouse, and a video display.

For purposes of this disclosure, information handling system 300 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 300 can include processing resources for executing machine-executable code, such as processor 302, a programmable logic array (PLA), an embedded device such as a System-on-a-Chip (SoC), or other control logic hardware. Information handling system 300 can also include one or more non-transitory computer-readable media for storing machine-executable code, such as software or data.

Although FIG. 2 shows example blocks of method 200 in some implementations, method 200 may include additional blocks, fewer blocks, different blocks, or differently arranged blocks than those depicted in FIG. 2. Those skilled in the art will understand that the principles presented herein may be implemented in any suitably arranged processing system. Additionally, or alternatively, two or more of the blocks of method 200 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that causes a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a RAM or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
monitoring, by a processor, an information handling system to detect whether the information handling system is in a low power state;
when the information handling system is in the low power state, monitoring power consumption of the information handling system; and
when the power consumption of the information handling system deviates from an expected power consumption of the information handling system, performing a diagnostic routine.

2. The method of claim 1, further comprising when the diagnostic routine determines that there is an issue with the information handling system, performing a remediation routine to resolve the issue.

3. The method of claim 1, further comprising if the diagnostic routine determines that there is an issue with the information handling system, then performing a remediation routine and triggering a service alert to resolve the issue.

4. The method of claim 1, further comprising if the diagnostic routine determines that there is an issue with the information handling system, then performing a remediation routine and updating a firmware to resolve the issue.

5. The method of claim 1, wherein an artificial intelligence model is used to determine if the power consumption of the information handling system deviates from the expected power consumption.

6. The method of claim 5, wherein the artificial intelligence model is a classification model.

7. The method of claim 1, wherein a deviation in the power consumption indicates an issue with a synchronous dynamic random access memory of the information handling system.

8. An information handling system, comprising:
a processor; and
a memory coupled to the processor, the memory having program instructions stored thereon that upon execution cause the processor to:
monitor the information handling system to detect whether the information handling system is in a low power state;
when the information handling system is in the low power state, monitor power consumption of the information handling system; and
when the power consumption of the information handling system deviates from an expected power consumption of the information handling system, perform a diagnostic routine.

9. The information handling system of claim 8, wherein the execution of the program instructions further causes the processor to perform a remediation routine to address an issue with the information handling system as determined by the diagnostic routine.

10. The information handling system of claim 8, wherein the execution of the program instructions further causes the processor to perform a remediation routine and trigger a service alert to resolve an issue with the information handling system as determined by the diagnostic routine.

11. The information handling system of claim 8, wherein the execution of the program instructions further causes the processor to perform a remediation routine and update a firmware to resolve an issue with the information handling system as determined by the diagnostic routine.

12. The information handling system of claim 8, wherein an artificial intelligence model is used to determine if the power consumption of the information handling system deviates from the expected power consumption.

13. The information handling system of claim 12, wherein the artificial intelligence model is a classification model.

14. The information handling system of claim 8, wherein a deviation in the power consumption indicates an issue with a synchronous dynamic random access memory of the information handling system.

15. A non-transitory computer-readable medium to store instructions that are executable to perform operations comprising:
monitoring an information handling system to detect whether the information handling system is in an off state;
when the information handling system is in the off state, monitoring power consumption of the information handling system; and
when the power consumption of the information handling system deviates from an expected power consumption of the information handling system, performing a diagnostic routine.

16. The non-transitory computer-readable medium of claim 15, wherein the operations further comprise performing a remediation routine to resolve an issue with the information handling system as determined by the diagnostic routine.

17. The non-transitory computer-readable medium of claim 15, wherein the operations further comprise performing a remediation routine and triggering a service alert to resolve an issue with the information handling system as determined by the diagnostic routine.

18. The non-transitory computer-readable medium of claim 15, wherein the operations further comprise performing a remediation routine and updating a firmware to resolve an issue with the information handling system as determined by the diagnostic routine.

19. The non-transitory computer-readable medium of claim 15, wherein an artificial intelligence model is used to determine if the power consumption of the information handling system deviates from the expected power consumption.

20. The non-transitory computer-readable medium of claim 19, wherein the artificial intelligence model is a classification model.
